(19) United States
(12) Patent Application Publication
(10) Pub. No.: US 2006/0223492 A1
(43) Pub. Date: Oct. 5, 2006

(54) System and method for alert notification to affected mobile units in a geographic area

(76) Inventors: Frances Mu-Fen Chin, Napersville, IL (US); Peggy Hasan, Aurora, IL (US); Sandra Lynn True, St. Charles, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/097,074

(22) Filed: Apr. 1, 2005

(51) Int. Cl. H04M 11/04

(52) U.S. Cl. 455/404.1; 455/414.1

(57) ABSTRACT

A wireless telecommunication system is used to provide alert notifications such as weather alerts to affected mobile units in a geographic area. In one embodiment, responsive to receiving an alert notification, an MSC identifies one or more affected mobile units located within the coverage area and sends a message including indicia of the alert notification to the affected mobile units. In another embodiment, a subscriber service center (SSC) receives an alert notification and consults a database to identify one or more mobile units eligible to receive the alert notification. The SSC queries a mobile position center to identify one or more affected mobile units located within the coverage area and sends a message including indicia of the alert notification to the affected mobile units.

### FIELD OF THE INVENTION

This invention relates generally to wireless telecommunication systems and, more particularly, to providing weather alerts and other alert notifications to affected mobile units in a geographic area.

### BACKGROUND OF THE INVENTION

A variety of alert notification systems are known for providing weather alerts and other alerts, such as police, fire and emergency alerts to the public. Typically, the alert notification is generated from a public authority (e.g., community, state or national authority) and is targeted to the public residing within an affected geographic area. The mechanism for providing alert notification can range in sophistication from warning sirens to warning tones or announcements broadcast over radio and television. For example, the National Weather Service can promulgate tones or announcements over radio and television to convey weather forecasts, warnings and “watches” (i.e., warnings associated with observed weather conditions).

While alert notification systems provide an important service to the public, it seems that the mechanisms for providing alert notification have not kept pace with advances in technology. In recent years, for example, wireless telecommunication systems have become well known in which persons may initiate or receive messages using mobile units (e.g., wireless phones) as they roam about a coverage area served by a wireless telecommunication infrastructure. Depending on the capability of the mobile units, the messages may comprise voice, text or image information. Presently, however, wireless telecommunication systems do not deliver alert notifications, such as National Weather Service alerts or other emergency alerts. Consequently, users of mobile units may stay uninformed of weather alerts or other emergency conditions unless they become informed by other means such as warning sirens or radio or television alerts.

### SUMMARY OF THE INVENTION

These problems are addressed and a technical advance is achieved in the art by a feature whereby a wireless telecommunication system is used to deliver alert notifications to affected mobile units in a geographic area.

In one embodiment, a mobile switching center (MSC) receives an alert notification affecting a coverage area served by the MSC. The alert notification may comprise, for example, a weather alert generated by the National Weather Service. The MSC identifies one or more affected mobile units located within the coverage area and sends a message including indicia of the alert notification to the affected mobile units.

In another embodiment, a subscriber service center (SSC) receives an alert notification associated with an affected geographic area. The alert notification may comprise, for example, a weather alert generated by the National Weather Service. The SSC consults a database to identify one or more mobile units eligible to receive the alert notification. The SSC queries a mobile position center to identify one or more affected mobile units located within the coverage area and sends a message including indicia of the alert notification to the affected mobile units.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented;

FIG. 2 is a message sequence diagram that shows a first method for providing alert notifications to mobile units in an affected geographic area; and

FIG. 3 is a message sequence diagram that shows a second method for providing alert notifications to mobile units in an affected geographic area.

### DESCRIPTION OF THE PREFERRED EMBODIMENT(S)

FIG. 1 shows a communication system 100 according to an exemplary embodiment of the invention that is operable to deliver alert notifications to affected mobile units in a geographic area. An alert notification center (ANC) 102 generates alerts comprising, for example and without limitation, weather alerts, police, fire or other emergency alerts to be delivered to the public within an affected area. In one embodiment, the ANC 102 coordinates the delivery of National Weather Service alerts to convey weather forecasts, warnings and watches to mobile units 104 (one shown) within a geographic area (or “site”) 106. The mobile unit 104 may comprise, without limitation, a mobile phone, laptop computer, personal digital assistant (PDA) or the like.

The mobile unit 104 is connected by wireless link 108 to a base station 110. The wireless link 108 may implement air interface technologies including but not limited to, CDMA, TDMA, GSM, UMTS or IEEE 802.11. The base station 110 is connected to a switching element 112 (as shown, a mobile switching center (MSC)). The MSC 112 may comprise, for example, an AUTOPLEX™ switching system, available from Lucent Technologies, Inc. The MSC 112 includes a controller 114 having a memory and processor, for storing and executing software routines for processing and switching calls and for providing various call features to calling or called parties. The MSC 112 may be configured for operation with generally any suitable circuit, cell, or packet switching technology. As will be appreciated, the MSC 112 is a functional element that may reside in a single device or may be distributed among multiple devices and/or locations.

The MSC 112 is connected to a home location register/visitor location register database 116 (hereinafter HLR/VLR). HLR/VLR functionality is well known in the art and will not be described in detail herein. Suffice it to say that the HLR/VLR 116 maintains service profiles, location information and activity status of various mobile units as they roam between various sites or between different communication systems. The MSC 112 uses this location information to determine which sites need to be included when call requests or other communications are directed to the mobile units. For example, with reference to FIG. 1, the MSC can query the HLR/VLR 116 to determine which mobile units 104 are located at site 106 and, accordingly, the MSC may use this information to set up a call or other communication to one or more of the mobile units 104 at site 106.

The MSC 112 is connected to the ANC 102 via network 118. The network 118 may comprise, for example, an IP network or the Public Switched Telephone Network (PSTN)). The network 118 may be implemented using any appropriate transmission, switching and routing technologies, including but not limited to Internet Protocol (IP) and Asynchronous Transfer Mode (ATM) technologies. As will be appreciated, the network may comprise or may be interconnected with a number of different types of networks including local area networks (LANs), wide area networks (WANs), metropolitan area networks (MANs), the Internet, virtual private networks (VPNs) and/or corporate intranets.

As shown, the MSC 112 is also connected to a subscriber service center (SSC) 120. The SSC 120 is a functional element that may reside in one or more physical devices, separately from or within the MSC 112. The SSC 120 is used in one embodiment of the present invention to receive and process alert notifications from the ANC and deliver to affected mobile units. The affected mobile units may comprise, for example, subscribers of an alert notification service presently located within an affected geographic area.

Functional elements within the SSC 120 include alert center 122, mobile positioning center (MPC) 124 and message system 126. In one embodiment, the alert center 122 functions as a gateway for alert notifications received from the ANC 102. The alert center 122 maintains a database that identifies mobile units subscribing to an alert notification service and directs alert notifications to the mobile units as may be appropriate. The alert center 122 queries the MPC 124 to determine the position of the mobile units. The MPC 124, in turn, queries the HLR/VLR 116 to determine the position of the mobile units within various sites (e.g., site 106). In one embodiment, the MPC 124 further maps the geographic area associated with an alert notification to one or more sites 106 of the telecommunication system. For example, the alert notification from the ANC may identify the affected geographic area using geo-location information such as latitude and longitude, or a center point location and radius, which may not directly correspond to various sites 106 of the telecommunication system 100. Advantageously, the MPC 124 is able to identify which sites 106 (and hence which mobile units 104) are included within the affected geographic area, and so inform the alert center 122. The message system 126 provides alert notification messages, tones, and the like to affected mobile units (i.e., mobile units in the affected geographic area) as directed by the alert center 122.

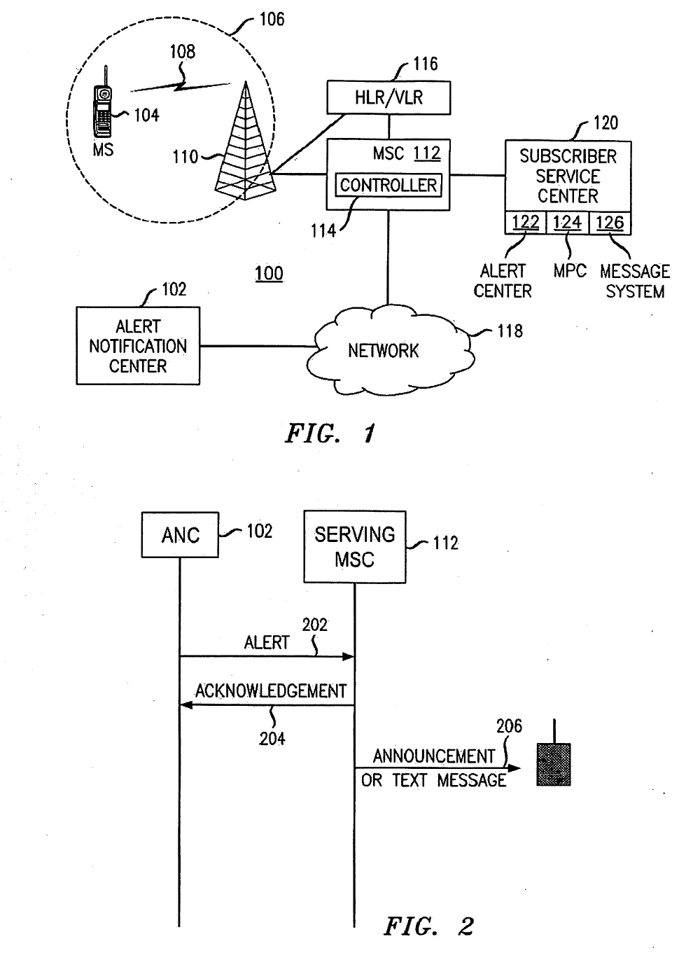

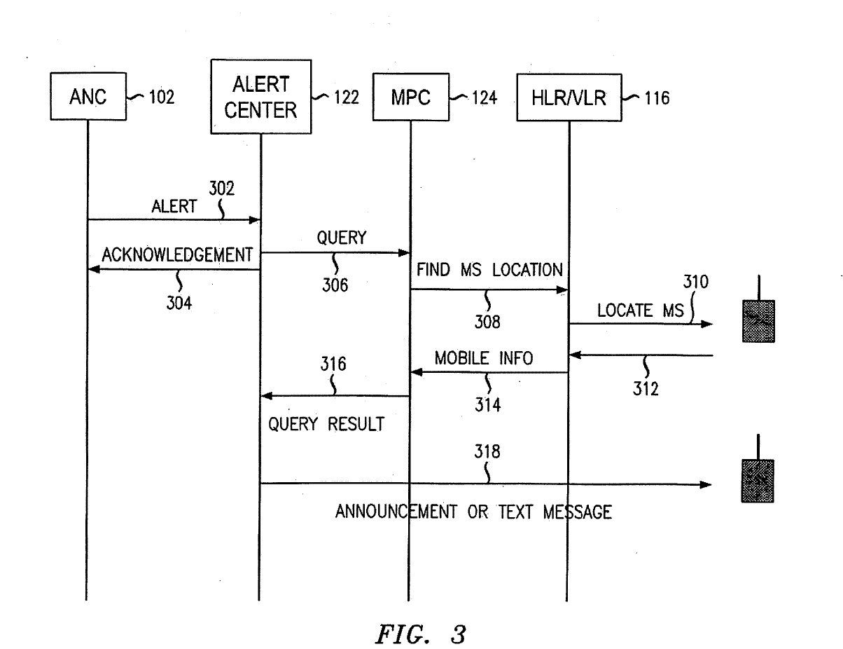

FIG. 2 and FIG. 3 are message sequence charts useful for showing different methods of providing alert notifications to mobile units in an affected geographic area. FIG. 2 depicts a message sequence between the ANC 102 and one or more serving MSCs 112; and FIG. 3 depicts a message sequence between the ANC 102 and alert center 122, MPC 124 and HLR/VLR 116 associated with one or more serving MSCs 112.

In FIG. 2, the ANC 102 detects an alert condition and sends an alert message 202 to one or more serving MSCs in the affected area. In one embodiment, the alert message 302 includes indicia of a specified alert but may or may not include indicia of an affected geographic area. For example, in the case of weather alerts, the alert message may contain a pre-defined weather alert code corresponding to a pre-specified weather alert category (e.g., flood alert, tornado warning, snow advisory, etc.) but may or may not include indicia of the affected area.

The alert message need not include indicia of the affected area if the ANC 102 knows which MSCs are affected by the alert condition, since in such case the ANC 102 can send the alert message 202 only to the affected MSCs. Alternatively, the alert message may include indicia of the affected area if the ANC 102 does not know which MSCs are affected. For example, it is contemplated the ANC 102 may send the alert message to a service provider without knowing which MSCs are affected or without knowing message addresses of the MSCs. In such case, the alert message preferably contains indicia of the affected geographic area such that the service provider can determine the affected MSCs and either forward the alert message to the affected MSCs or inform the ANC 102 such that the ANC can send alert message to the affected MSCs.

Responsive to the alert message 202, the serving MSC(s) return an acknowledgement message 204 to the ANC 102 indicating that they have received the alert message; and then the serving MSC(s) send a message 206 to their mobile units 104 as appropriate based on the alert received. The message 206 may comprise, for example and without limitation, an audio announcement, text message, tone or ring sequence indicative of the type of alert and/or geographic area associated with the alert.

In FIG. 3, the ANC 102 detects an alert condition and sends an alert message 302 to an Alert Center 122 in the affected area. In one embodiment, the alert message 302 includes indicia of a specified alert and indicia of an affected geographic area. For example, in the case of weather alerts, the alert message 302 may include a pre-defined weather alert code corresponding to a pre-specified category (e.g., tornado, snow advisory, etc.) and indicia of an affected geographic area for which the alert is intended. Responsive to the message, the Alert Center returns an acknowledgement message 304 to the ANC 102 indicating it has received the alert message and sends a query 306 to the MPC 124 to find the position of various mobile units that are eligible to receive an alert notification. In one embodiment, as has been described in relation to FIG. 1, the Alert Center maintains a database that identifies mobile units subscribing to an alert notification service (thereby defining mobile units eligible to receive alert notifications) and the Alert Center queries the MPC 124 to find the position of such subscribers.

The MPC 124, in turn, queries one or more HLR/VLRs 116 via message(s) 308 to find the location of the mobile units within various sites (e.g., site 106). Typically, the HLR/VLRs will already know the location of the mobile units, and already have updated their database accordingly, based on paging messages and responses previously exchanged. For example, the location of the mobile units at various sites may become known to the HLR/VLR coincident to initial registration of the mobile units upon power up at various sites or coincident to the mobile units originating or terminating calls at various sites. Optionally, the HLR/VLR 116 may send additional paging messages 310 and receive page responses 312 coincident to receiving a location query 308 from the MPC. In either case, the HLR/VLRs send responses 314 to the MPC including location information associated with the mobile units within various sites.

In one embodiment, as has been described in relation to FIG. 1, the MPC 124 further maps the location information associated with the mobile units at various sites to the geographic area associated with an alert notification. In such manner, the MPC 124 is able to identify which sites 106 (and hence which mobile units 104) are included within the geographic area associated with the alert. The MPC 124 sends a query response 316 to the Alert Center that identifies the affected sites and mobile units at the affected sites. Thereafter, the Alert Center (via message system 126) causes alert notification messages 318 (e.g., audio or text messages, tones, or the like) to be delivered to affected mobile units at the affected sites.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising the steps of:
receiving, at a mobile switching center (MSC), an alert notification affecting a coverage area served by the MSC;
identifying, by the MSC, one or more mobile units located within the coverage area, thereby defining affected mobile units; and
sending a message including indicia of the alert notification to the affected mobile units.

2. The method of claim 1, wherein the step of sending a message comprises sending one or more of: an audio announcement, text message, tone and ring sequence to the affected mobile units.

3. The method of claim 1, wherein the step of sending a message comprises sending indicia of a type of alert associated with the alert notification.

4. The method of claim 1, wherein the step of sending a message comprises sending indicia of a geographic area associated with the alert notification.

5. The method of claim 1, wherein the alert notification comprises a weather alert generated by the National Weather Service.

6. The method of claim 1, wherein the alert notification is generated from an alert notification center (ANC), the method comprising:
determining one or more MSCs having coverage areas affected by the alert notification, defining affected MSCs; and
sending the alert notification only to the affected MSCs.

7. A method comprising the steps of:
receiving an alert notification associated with an affected geographic area;
consulting a database to identify one or more mobile units eligible to receive the alert notification;
identifying which of the one or more mobile units are located within the affected geographic area, thereby defining affected mobile units; and
sending a message including indicia of the alert notification to the affected mobile units.

8. The method of claim 7, wherein the step of sending a message comprises sending one or more of: an audio announcement, text message, tone and ring sequence to the affected mobile units.

9. The method of claim 7, wherein the step of sending a message comprises sending indicia of a type of alert associated with the alert notification.

10. The method of claim 7, wherein the step of sending a message comprises sending indicia of a geographic area associated with the alert notification.

11. The method of claim 7, wherein the alert notification comprises a weather alert generated by the National Weather Service.

12. A subscriber service center comprising:
an alert center operable to receive an alert notification associated with an affected geographic area, the alert center consulting a database to identify one or more mobile units eligible to receive the alert notification;
a mobile position center operable to identify which of the one or more mobile units are located within the affected geographic area, thereby defining affected mobile units; and
a message system operable to send a message including indicia of the alert notification to the affected mobile units.
